(19) United States
(12) Patent Application Publication
(10) Pub. No.: US 2008/0069406 A1
(43) Pub. Date: Mar. 20, 2008

(54) Surveying Apparatus

(75) Inventors: Shunji MATSUO, Tokyo (JP); Homu TAKAYAMA, Saitama (JP); Takanori YACHI, Tokyo (JP); Masatoshi SAKURAI, Saitama (JP)

Correspondence Address: GREENBLUM & BERNSTEIN, P.L.C., 1950 ROLAND CLARKE PLACE, RESTON, VA, 20191, US

(73) Assignee: C/O PENTAX INDUSTRIAL INSTRUMENTS CO., LTD., Tokyo (JP)

(21) Appl. No.: 11/857,601

(22) Filed: Sep. 19, 2007

(30) Foreign Application Priority Data
Sep. 19, 2006 (JP) 2006-253103

(51) Int. Cl. G06K 9/00

(52) U.S. Cl. 382/106

(57) ABSTRACT

A surveying apparatus is provided that includes a digital camera, an area-size presetter, a distance detector, an extracted-area calculator, and a trimming processor. The area-size presetter is used to preset the actual size of an extracted area to be imaged around a measurement point. The distance detector measures a distance to the measurement point. The extracted-area calculator determines the extracted area within an image captured by the digital camera. The extracted area is determined based on the distance and the preset size of the extracted area. The trimming processor extracts a trimming image including the extracted area from the captured image.

### BACKGROUND OF THE INVENTION

1. Field of the Invention

The present invention relates to a surveying apparatus provided with a camera for capturing an image in a surveying field.

2. Description of the Related Art

On some occasions, a scene including a measurement point is captured and the corresponding image data is stored together with measurement data during the surveying. Although an image of the surveying field can be photographed by a normal camera, there is a system provided that captures a peripheral image for each measurement point by using an image capturing device provided inside the surveying apparatus.

### SUMMARY OF THE INVENTION

The area of the image of a scene to be captured when surveying varies with the distance to the measurement point. In particular, when the distance to the measurement point is large, most of the peripheral part of the captured image unnecessary. Hence, if such an image is stored in a recording medium, memory capacity is wasted, and time is wasted in transmitting the image data.

Therefore, an object of the present invention is a digital-camera-provided surveying apparatus that obtains an image of the area surrounding a measurement point efficiently.

According to the present invention, a surveying apparatus is provided that includes a digital camera, an area-size presetter, a distance detector, an extracted-area calculator, and a trimming processor.

The area-size presetter is used to preset the actual size of an extracted area to be imaged around a measurement point. The distance detector measures the distance to the measurement point. The extracted-area calculator determines the extracted area within a captured-image captured by the digital camera. The extracted area is determined based on the distance and the preset size of the extracted area. The trimming processor extracts a trimming-image including the extracted area from the captured-image.

### BRIEF DESCRIPTION OF THE DRAWINGS

The objects and advantages of the present invention will be better understood from the following description, with reference to the accompanying drawings in which:

FIG. 1 is a perspective view showing the front appearance of a surveying apparatus provided with a digital camera, to which an embodiment of the present invention is applied;

FIG. 2 is a schematic block diagram of the surveying apparatus illustrated in FIG. 1;

FIG. 3 schematically illustrates the relationship between the position of the surveying apparatus and an area to be imaged when surveying a measurement point and capturing an image with the digital camera unit;

FIG. 4 schematically illustrates the relationship between the number of pixels corresponding to an imaging area A1 and the number of pixels corresponding to an area A2;

FIG. 5 schematically illustrates the positional relationship between the surveying apparatus and the imaging area when using the angles of view to calculate the dimensions in pixels of the extracted area;

FIG. 6 schematically illustrates an example of a trimming image that is extracted by adopting one of the image-size standards;

FIG. 7 is an example of the trimming image when an area other than the extracted area is colored in monochrome;

FIG. 8 is an example of the trimming image when the area of the trimming image is equivalent to the extracted area; and

FIG. 9 is a flowchart of the trimming-image extraction and storing process.

### DESCRIPTION OF THE PREFERRED EMBODIMENTS

The present invention is described below with reference to the embodiments shown in the drawings.

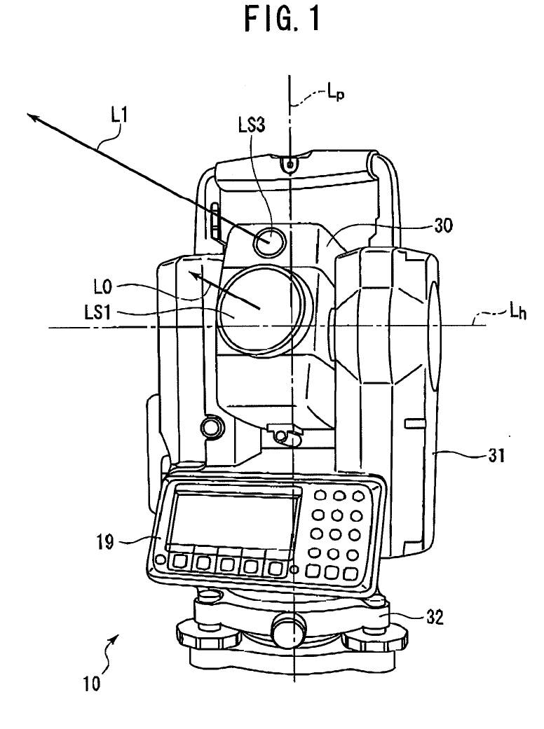

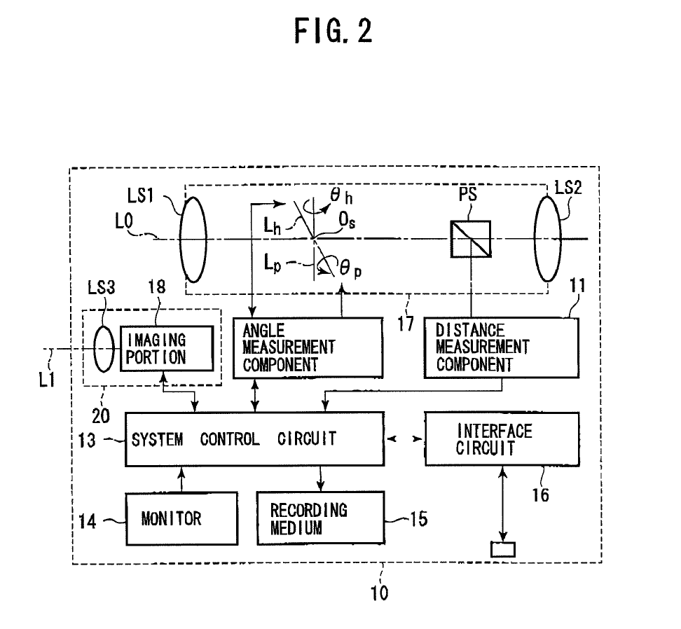

FIG. 1 is a perspective view showing the front appearance of a surveying apparatus provided with a digital camera, to which an embodiment of the present invention is applied. FIG. 2 is a schematic block diagram of the surveying apparatus illustrated in FIG. 1.

The surveying apparatus 10 can be of any type if it includes a distance measurement system, such as a total station, a theodolite, a survey level, etc. However, in the following descriptions, a total station will be used in the example of the surveying apparatus 10.

The surveying apparatus 10 includes a telescope block 30, a support block 31 (which corresponds to the main body of the surveying apparatus 10) and a leveling board 32. The telescope block 30 is rotatably supported about a horizontal axis Lh by the support block 31 from both sides. Furthermore, the support block 31 is placed on the leveling board 32 and rotatably supported about a vertical axis Lp.

The surveying apparatus 10 includes a sighting telescope 17 in which the horizontal axis Lh and the vertical axis Lp perpendicularly intersect at a sighting origin Oₛ on the optical axis L0 (or collimation axis) of the sighting telescope 17. Thereby, when the telescope block 30 is rotated about the horizontal axis Lh and the vertical axis Lp, the altitude and the horizontal angle in the direction towards which the sighting telescope 17 is sighted are obtained as the angle θa about the horizontal axis Lh (the altitude) and the angle θh about the vertical axis Lp (the horizontal angle).

The optical axis L0 of an objective lens system LS1 of the sighting telescope 17 is split by a prism PS into a main beam and an offshoot beam such that the main beam reaches an eyepiece lens system LS2 and the offshoot beam reaches a distance-measurement component 11. The distance-measurement component 11 detects an oblique distance to a measurement point (which is sighted) by using a phase-modulation measurement method, a pulse laser method, or the like, while an angle-measurement component 12 detects the vertical angle θp and the horizontal angle θh.

The distance-measurement component 11 and the angle-measurement component 12 are each connected to a system control circuit 13, whereby they are controlled by signals from the system control circuit 13. The distance-measurement component 11 detects a distance in accordance with signals from the system control circuit 13, and outputs the detected data or measurement data to the system control circuit 13.

On the other hand, the angle-measurement component 12 continuously detects angles at regular time intervals, and outputs the detected data or measurement data to the system control circuit 13 when it is required. The detected data, such as oblique distance, horizontal angle, and vertical angle, are processed in the system control circuit 13.

Furthermore, a digital camera unit 20 is integrally provided inside the telescope block 30. The digital camera unit 20 is provided with an imaging portion 18 and a photographic lens system LS3 and an imaging device, such as a CCD. The optical axis L1 of the photographic lens system LS3 is arranged to be parallel with the collimation axis L0 of the sighting telescope 17, so that the imaging portion 18 is able to capture an image in the sighting direction through the photographic lens LS3. Image data obtained by the imaging portion 11 is transmitted to the system control circuit 13 and displayed on a monitor 14. Furthermore, the image data can also be recorded onto a detachable recording medium 15, such as an IC card, etc.

The system control circuit 13 is also connected to switches and a display device (e.g. LCD) provided on an operating panel 19. Furthermore, an interface circuit 16 is connected to the system control circuit 13, whereby the measurement data and the image data can be output to an external device, such as a data collector (not shown) or a computer (not shown), via the interface circuit 16.

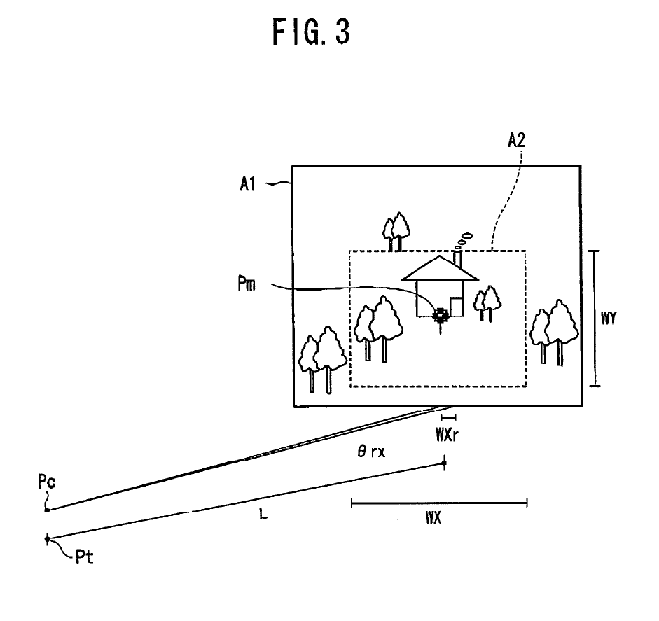

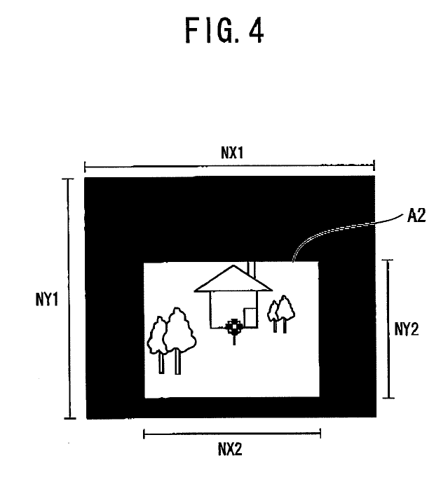

Referring to FIGS. 3 and 4, a principle of a trimming process for the present embodiment will be explained. FIG. 3 schematically illustrates the relationship between the position of the surveying apparatus 10 and a peripheral area to be imaged when surveying a measurement point or a target Pm by using the surveying apparatus 10 and capturing an image around the measurement point or the target Pm by the digital camera unit 20. Furthermore, FIG. 4 schematically illustrates the relationship between the number of pixels corresponding to an imaging area A1 and the number of pixels corresponding to an extracted area A2 that is being prepared for extraction from A1 as a peripheral image.

FIG. 3 illustrates the situation in which the measurement point or the target Pm, removed from the surveying apparatus 10 by distance “L”, is being surveyed by the surveying apparatus 10. Here, the point Pt coincides with the sighting origin Os of the sighting telescope 17. Furthermore, the point Pa corresponds to the viewpoint of the digital camera unit 20 and the imaging area A1 is imaged via the photographic lens system LS3 by the imaging portion 18 or the digital camera unit 20. However, most of the peripheral part of the image area A1 is unnecessary since the imaging area A1 is too broad a peripheral image to serve as a reference for the measurement point.

In general, the extract of the actual area which should be recorded as the peripheral image of the measurement point Pm is known in advance. Therefore, in the present embodiment, the actual or physical width WX and height WY that should be imaged around the measurement point Pm are preset by the user. Thereby, the extracted area A2, which should be extracted from the imaged area A1, is calculated from the measurement distance “L” to the measurement point Pm and the given width WX and height WY.

When denoting the resolving power (as an angle) in the lateral direction per pixel of the imaging device as θrx, the width WXr in the plane including the measurement point Fm removed from the surveying apparatus 10 by distance “L” corresponding to one pixel is represented as WXr=L*tan(θrx). Therefore, the number of pixels in the lateral direction, denoted NX2, required to extract the area A2 from the imaging area A1, is derived as NX2=WX/WXr.

Similarly, the number of pixels in the vertical direction, denoted NY2, required to extract the extracted area A2 from the imaging area A1, is derived as NY2=WY/WYr. Here WYr denotes the height in the plane including the measurement point Pm, which is removed from the surveying apparatus 10 by distance “L”, and corresponds to one pixel, and WYr is derived as WYr=L*tan(θry) when denoting resolving power (as an angle) in the vertical direction per pixel of the imaging device as θry. Here, the resolving power corresponds to the horizontal angle of view θrx and the vertical angle of view θry for one pixel.

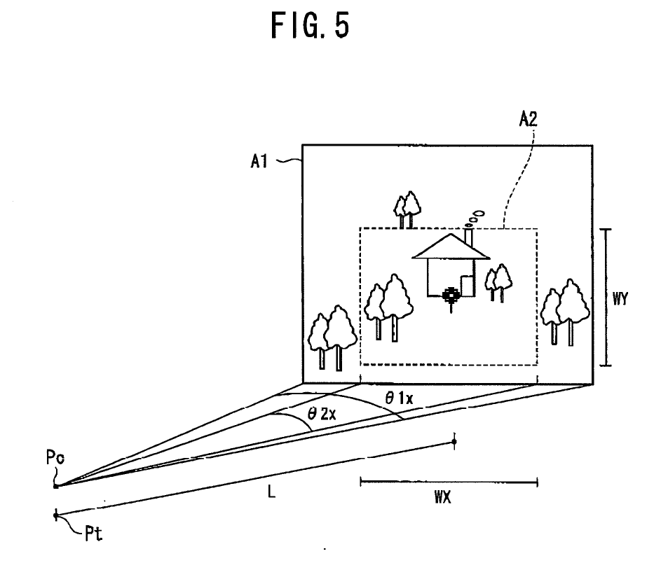

An alternative method of calculating the number of pixels for extracting the extracted area A2 is explained with reference to FIG. 5 in which the angles of view are used calculate the number of pixels for the extracted area in the lateral and the vertical directions.

When the horizontal and vertical angles of view required for capturing the area A2 in the plane removed from the surveying apparatus by distance “L” are denoted as θ2x and θ2y, corresponding to the preset width WX and height WY, the angles are derived by the following formulas: θ2x=tan⁻¹(WX/L) and θ2y=tan⁻¹(WY/L). Therefore, the number of pixels NX2 and NY2 in the lateral and the vertical directions for the extracted area A2 can be derived as NX2=(NX1/θ1x)*θ2x and NY2=(NY1/θ1y)*θ2y, where θ1x and θ1y represent the horizontal and the vertical angle of view for the digital camera unit 20 and NX1 and NY1 represent the number of pixels in the lateral and the vertical directions, respectively. Note that in FIG. 5, only the horizontal angle of view is depicted and the vertical angle of view is omitted.

Accordingly, the number of pixels NX2 and NY2, corresponding to the lateral and the vertical lengths of the extracted area A2, are obtained, and hence the image of the area corresponding to the preset actual width WX and height WY can be extracted by extracting an image of the size NX2*NY2 from the captured image (imaging area A1) with the center of the captured image or the measurement point Pm at the center.

Note that when selecting the center of the extracted area as the measurement point Pm, the positional data of the measurement point Pm in the captured image may be prerecorded on a non-volatile recording medium, and thereby the extracted area may be determined in accordance with this data. Namely, the positional data includes the positional relationship between the digital camera unit 20 and the sighting telescope 17, whereby the position is calculated in accordance with the distance to the measurement point and the given positional relationship. The image is assumed to be captured at the position where it keeps the positional relationship to the sighting telescope sighted to the measurement point.

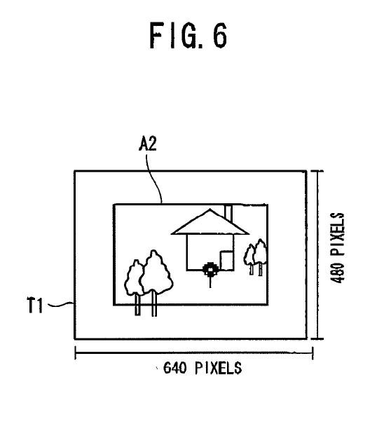

Although various standards for the number of pixels in the lateral and vertical directions of a digital image are provided, the actual width WX and height WY supplied by the user might not always match aspect ratios of these standards. Referring to FIGS. 6-9, three different ways of trimming such image are explained using NX2=495 and NY2=375 example dimensions.

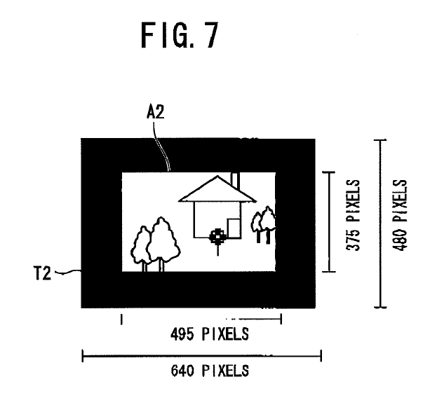

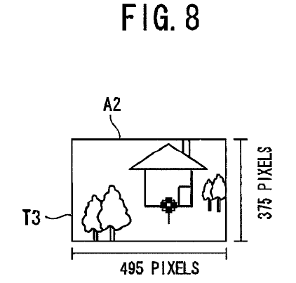

FIGS. 6 and 7 are examples where the smallest image-size standard to include the extracted area A2 is adopted. On the other hand, FIG. 8 represents an example where an image size calculated from the present values is adopted as a trimming image.

When NX2=495 and NY2=375, the smallest encompassing image-size standard is VGA (640*480). Therefore, in the example of FIG. 6, the VGA image area including the extracted area A2 located at the center is extracted from the captured image A1 as the trimming image T1. Note that the smallest image-size standard is selected by comparing the calculated pixel number NX and NY with the lateral and vertical dimensions of each standard, beginning with the standard having the smallest number of pixels and proceeding in order.

In the example of FIG. 7, a trimming image T2 corresponds to an image in which the periphery of the trimming image T1 of FIG. 6, excluding the extracted area A2, is colored in monochrome so that data to be stored on the recording medium is reduced. Note that the monochrome area may be implemented as a blacked-out area and the measurement data may also be displayed or printed inside the monochrome area. Furthermore, in the example of FIG. 8, a trimming image T3 is obtained using extracted image data only for the calculated extracted area from the captured image, and thus, independently of image-size standards.

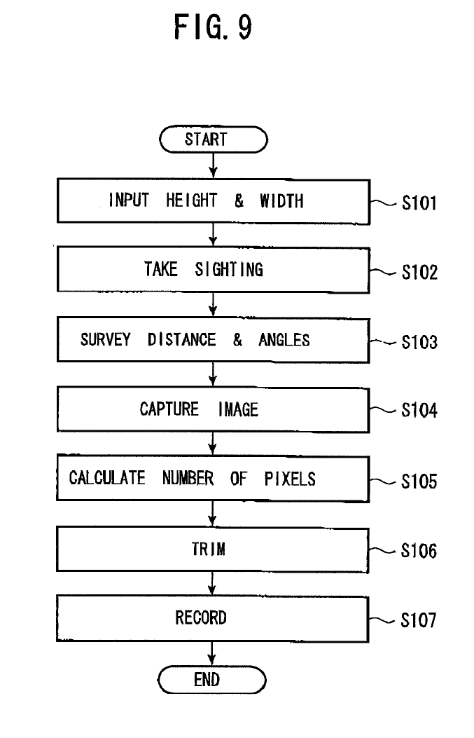

Next, trimming-image extraction and storage carried out in the surveying apparatus of the present embodiment will be explained with reference to the flowchart of FIG. 9.

In Step S101, the actual width and height of the area to be captured around a measurement point are input by the user into the surveying apparatus to through operating the operating panel 19. The input values are then stored in memory (not shown) provided inside the system control circuit 13.

In Step S102, the surveying apparatus 10 is operated and the sighting telescope 17 is sighted on a target or a measurement point. Distance measurement and angle measurement are then carried out for the target.

In Step S104, an image around the target is captured by the digital camera unit 20 and temporally stored in the memory provided inside the system control circuit 13. Next, in Step S105, the lateral and vertical pixel dimensions of the extracted area are calculated using the measured distance to the target and the user preset width and height.

In Step S106, the trimming image is extracted by trimming the captured image using one of the methods explained with reference to FIGS. 6 to 8, on the basis of the numbers of pixels that were calculated in Step S105. The trimming image extracted in Step S106 is stored on the recording medium 15 in Step S107 and the trimming-image extraction and storage process ends.

As described above, according to the present embodiment, a peripheral image of suitable size surrounding a measurement point can be automatically obtained by a surveying apparatus provided with a digital camera by presetting the physical width and height that are required to be imaged around the measurement point, regardless of the distance to the measurement point. Thereby, the capacity of the recording medium is saved and the time taken to transmit data is shortened. Furthermore, according to the present embodiment, a suitable peripheral image can be obtained without providing an optical zoom mechanism for the digital camera unit, or unnecessarily increasing the quantity of data by interpolating the image data in order to perform a digital zoom of the captured image, or manually trimming in order to extract the required area from the captured image.

Note that the preset data for trimming may also be given in terms of combination of at least two of the following factors: height, width, diagonal length and a predetermined aspect ratio. Furthermore, the aspect ratio may be selected from a list or may be set arbitrarily by the user.

Although the embodiment of; the present invention has been described herein with reference to the accompanying drawings, obviously many modifications and changes may be made by those skilled in this art without departing from the scope of the invention.

The present disclosure relates to subject matter contained in Japanese Patent Application No. 2006-253103 (filed on Sep. 19, 2006) which is expressly incorporated herein, by reference, in its entirety.

1. A surveying apparatus comprising:
a digital camera;
an area-size presetter that is used to present the actual size of an extracted area to be imaged around a measurement point;
a distance detector that measures the distance to the measurement point;
an extracted-area calculator that determines an extracted area within an image captured by said digital camera, where the extracted area it determined based on the distance and the preset size of the extracted area; and
a trimming processor that extracts a trimming image including the extracted area from the captured image.

2. The surveying apparatus according to claim 1, wherein at least one of width or height is given to preset the size of the extracted area.

3. The surveying apparatus according to claim 1, wherein the trimming image is trimmed away by adopting the smallest image-size standard that includes the extracted area.

4. The surveying apparatus according to claim 3, wherein an area of the trimming image other than the extracted area being is colored in monochrome.

5. The surveying apparatus according to claim 1, wherein the trimming image is equivalent to the extracted area.

6. The surveying apparatus according to claim 1, further comprising a recording medium for storing the trimming image.

7. The surveying apparatus according to claim 1, wherein the center of the extracted area is set to the measurement point.

8. A surveying apparatus according to claim 7, wherein the position of the measurement point in the captured image is prerecorded on a recording medium.

9. A surveying system comprising:
a digital camera;
an area-size presetter that is used to preset the actual size of an extracted area to be imaged around a measurement point;
a distance detector that measures the distance to the measurement point;
an extracted-area calculator that determines an extracted area within an image captured by said digital camera, where the extracted area is determined based on the distance and the preset size of the extracted area; and
a trimming processor that extracts a trimming image including the extracted area from the captured image.
